(19) United States
(12) Patent Application Publication
(10) Pub. No.: US 2020/0338609 A1
(43) Pub. Date: Oct. 29, 2020

(54) METHOD FOR CHANNEL DECOUPLING OF WHOLE-ROLLER FLATNESS METER FOR COLD-ROLLED STRIP

(71) Applicant: YANSHAN UNIVERSITY, Qinhuangdao City (CN)

(72) Inventors: Hongmin Liu, Qinhuangdao City (CN); Huaxin Yu, Qinhuangdao City (CN); Dongcheng Wang, Qinhuangdao City (CN); Yanghuan Xu, Qinhuangdao City (CN); Tongyuan Zhang, Qinhuangdao City (CN)

(21) Appl. No.: 16/859,020

(22) Filed: Apr. 27, 2020

(30) Foreign Application Priority Data
Apr. 28, 2019 (CN) 201910347862.4

(51) Int. Cl. B21B 37/28; B21B 38/02; G06F 17/16

(52) U.S. Cl. CPC B21B 37/28; B21B 38/02; B21B 2265/12; B21B 2263/04; B21B 2267/28; G06F 17/16

(57) ABSTRACT

The present invention discloses a method for channel decoupling of a whole-roller flatness meter for a cold-rolled strip. The method includes the following steps: 1, setting a channel number and a channel breadth of the flatness meter; 2, obtaining an influence matrix under the condition of coupled channels; 3, calculating an inverse matrix of the influence matrix; 4, decoupling the channel by the inverse matrix of the influence matrix; and 5, obtaining flatness distribution after channel decoupling. The present invention decouples the channel of the whole-roller flatness meter by inverting the influence matrix and multiplying with the detection force vector. The present invention reproduces the true force vector and flatness distribution, and provides a new method for improving the flatness detection accuracy.

### CROSS REFERENCE TO RELATED APPLICATIONS

This application claims priority under 35 U.S.C. § 119 to Chinese Patent Application No. 201910347862.4 filed Apr. 28, 2019, the entirety of which is incorporated by reference herein.

### TECHNICAL FIELD

The present invention belongs to the field of strip rolling, and particularly relates to a method for channel decoupling of a whole-roller flatness meter for a cold-rolled strip.

### BACKGROUND

With the advantages of high performance and high precision, cold-rolled strips are widely used in industrial manufacturing sectors such as automobiles, home appliances, construction and electronics. Cold-rolled strips are high-value-added (HVA) products. The technical level of strip production demonstrates a country's ability to produce iron and steel and has already become a characteristic of a strong country of iron and steel industry and an important symbol of a country's industrialization level. Flatness is an important quality indicator of cold-rolled strip. Poor flatness will cause difficulties to the subsequent processes and lead to the occurrence of accidents like strangled rolls or broken strips and may even damage the rolling mill in serious cases.

Flatness detection is the key to control flatness and improve the flatness quality. Flatness meters are necessary high-end instruments for producing advanced cold-rolled strip and realizing intelligent production process. There are various types of cold-rolled strip flatness meters, such as multi-piece type (segmented type), probe type and whole-roller type. Flatness meters technology has been monopolized by a few large international companies for a long time. In recent years, China has made major progress in the research of cold-rolled strip flatness meters, and independently developed the whole-roller flatness meter.

The whole-roller flatness meter is provided therein with 2 to 4 elongated holes in the axial direction near the surface inside the detection roll. A series of sensors are installed in the holes. The sensors each have an axial width of 26 mm and the detection channels are distinguished by the corresponding axial position of each sensor in the holes. The whole-roll type flatness meter is different from the probe type flatness meter in which sensors are spirally arranged on the detection roll. There are fewer mounting holes on the detection roll of the whole-roll flatness meter and the sensors are arranged next to each other along a straight line, which simultaneously detect the flatness of the strip on the same cross section to ensure synchronous flatness detection. However, because the sensors are arranged next to each other in the holes, the adjacent channels overlap and coupled obviously, causing errors in flatness detection. Therefore, it is necessary to decouple the channels for accuracy. At present, there are no accurate decoupling methods reported in the world.

### SUMMARY

An objective of the present invention is to provide a method for eliminating interference between channels of a whole-roller flatness meter, so as to improve the flatness detection accuracy.

The present invention provides a method for channel decoupling of a whole-roller flatness meter for a cold-rolled strip, including the following steps:

a, setting a channel number n and a channel breadth b of the flatness meter;

b, obtaining an influence matrix under the condition of signal interference between the channels, which includes the following steps:

b1, making a temporary variable i=1;

b2, making a temporary variable j=1;

b3, using a calibration device to apply a calibration force to an i channel of the flatness meter;

b4, recording an analog/digital (AD) influence value of the i channel on a j channel;

b5, determining whether j=n is true; if yes, going to b6; if not, making j=j+1 and returning to b4;

b6, determining whether i=n is true; if yes, going to b7; if not, making i=i+1 and returning to b3;

b7, making a temporary variable i=1;

b8, making a temporary variable j=1;

b9, calculating an influence coefficient βⱼᵢ=αⱼᵢ/αⱼⱼ of the i channel on the j channel;

b10, determining whether j=n is true; if yes, going to b11; if not, making j=j+1 and returning to b9;

b11, determining whether i=n is true; if yes, going to b12; if not, making i=i+1 and returning to b9; and

b12, forming an influence matrix B̅ of coupled channels with all Bⱼᵢ , B̅ being a square matrix, where j is a row number of the matrix, ranging from 1 to n, and i is a column number of the matrix, ranging from 1 to n;

c, calculating an inverse matrix (B̅)⁻¹ of the influence matrix;

d, using the inverse matrix of the influence matrix to decouple the channels according to a measured signal of the flatness meter; and

e, obtaining flatness distribution after channel decoupling.

Preferably, step d includes the following steps:

d1, setting a detection force signal Hᵢ of the flatness meter, i ranging from 1 to n, and forming a column vector H̅ with Hᵢ; and

d2, multiplying the inverse matrix (B̅) ⁻¹ of the influence matrix by the column vector H̅ to obtain a channel-decoupled true force vector F̅, where the true force vector F̅ has a total of n elements, and each element is Fᵢ.

Preferably, step e includes the following steps:

e1, setting a total strip tension T, a strip breadth B and a mean strip thickness h, and calculating a mean strip tensile stress σₘₑₐₙ=T/(Bh);

e2, dividing the strip breadth B by the channel breadth b and rounding to obtain a temporary integer mᵢ;

e3, determining whether m₁ is an odd number; if yes, making a strip-covered channel number of the flatness meter m=m₁ and going to e4; if not, making the strip-covered channel number of the flatness meter m=m₁+1, and going to e4;

e4, making a left boundary number of the strip-covered channel number of the flatness meter m_{z} =(n−m)/2+1 and a right boundary number of the strip-covered channel number of the flatness meter m_{y}=n−(n−m)/2;

e5, calculating a mean force

$$\overline{F} = {\sum }_{i = {m}_{z}}^{{m}_{y}} {F}_{i} \text{/} m ;$$

and

e6, setting an elastic modulus E and a Poisson's ratio ν of a strip, and calculating true flatness distribution

$${ɛ}_{i} = \frac{\overline{F} - {F}_{i}}{\overline{F}} {σ}_{m e a n} \frac{1 - {υ}^{2}}{E} \times 1 {0}^{5} ,$$

where i ranges from m_{z} to m_{y}.

Compared with the prior art, the present invention has the follow advantages:

The present invention decouples the channel of the whole-roller flatness meter by inverting the influence matrix and multiplying with the detection force vector, thereby reproducing the true force vector and flatness distribution and improving the flatness detection accuracy.

### BRIEF DESCRIPTION OF DRAWINGS

FIGS. 1a and 1b are structural diagrams of a whole-roller flatness meter according to the present invention.

FIG. 2 is a flow diagram according to the present invention.

FIGS. 3a and 3b are structural diagrams of a calibration device.

FIG. 4 is a comparison diagram of flatness distribution before and after channel decoupling.

### REFERENCE NUMERALS

1. motor, 2. calibration bracket, 3. calibration beam, 4. calibration weight, 5. detection roll, 6. bearing seat, 7. pressure roller, 8. calibration rod, 9. sensor, 10. elongated hole, and 11. Detection channel.

### DETAILED DESCRIPTION

The technical solutions in the examples of the present invention are clearly and completely described with reference to the accompanying drawings in the examples of the present invention. As will be apparent, the described examples are merely a part rather than all of the examples of the present invention. All other examples obtained by a person of ordinary skill in the art based on the examples of the present invention without creative efforts should fall within the protection scope of the present invention.

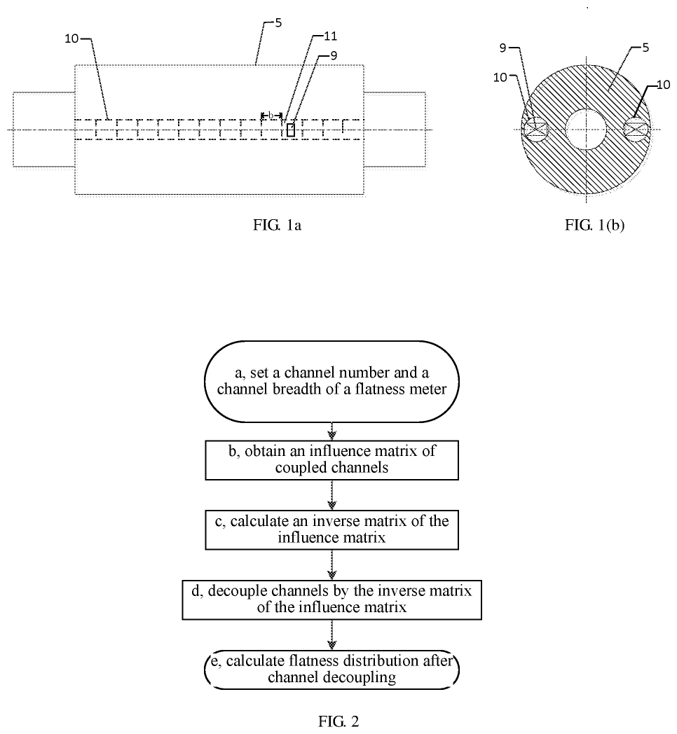

FIGS. 1a and 1b are structural diagrams of a whole-roller flatness meter according to the present invention. A plurality of elongated holes 10 are provided near a surface inside a detection roll 5 of a whole-roller flatness meter along an axial direction thereof. There are usually 2-4 elongated holes arranged in a circumferential array. FIGS. 1a and 1b show two elongated holes 10 penetrating the entire detection roll 5 in the axial direction. The elongated holes 10 are divided into a plurality of channels 11 at equal distances in the axial direction. Each channel 11 is provided therein with a sensor 9, and an axial length of the channel 11 is greater than or equal to an axial length of the sensor 9. In a preferred implementation, the axial length of the channel 11 is 26 mm, that is, an axial central distance between every two adjacent sensors 9 is 26 mm

In the present invention, in order to reduce a flatness detection error caused by the coupling between adjacent channels 11, the channels need to be accurately decoupled. As shown in FIG. 2, a decoupling process includes the following steps:

a, set a channel number of the flatness meter n=57, a channel breadth b=26 mm, where the channel number is equal to the number of sensors in one elongated hole, that is, a plurality of sensors 9 are provided one after another along the elongated hole 10.

b, obtain an influence matrix under the condition of signal interference between the channels. A calibration force is applied to an i channel by a calibration device, and an analog/digital (AD) influence value of the i channel on a j channel is recorded. In an actual calibration process, the AD influence values of the i channel on ≤i −2 and >i+2 channels are approximately zero. Therefore, it is only necessary to record the AD influence value of the i channel on an i−1 channel, the i channel and an i+1 channel. The recorded results are shown in Table 1 below. In the table, a first column indicates a code of a channel applying a calibration force, a second column indicates an AD influence value of a channel applying a calibration force on a previous channel, a third column indicates an AD influence value of a channel applying a calibration force on itself, and a fourth column indicates an AD influence value of a channel applying a calibration force on a subsequent channel.

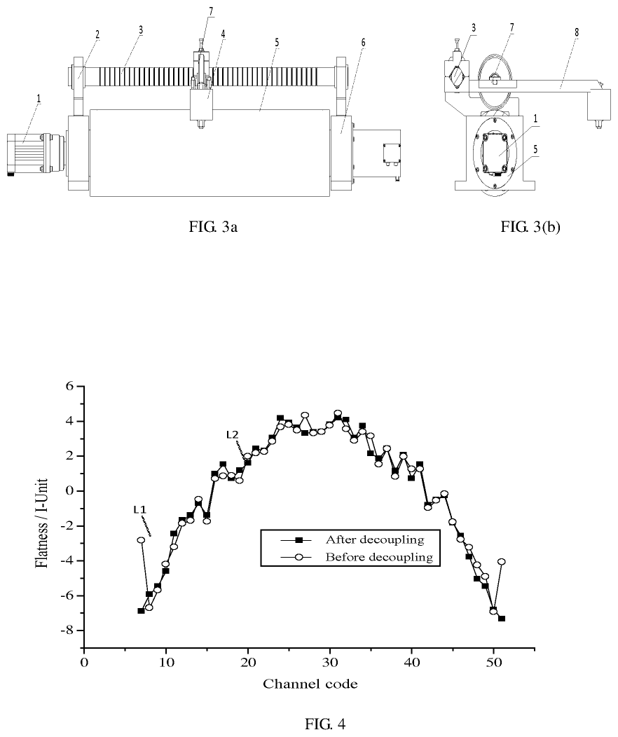

The main structure of the calibration device is shown in FIGS. 3a and 3b. During a calibration process, the detection roll 5 of the flatness meter is driven by a motor 1 to rotate within a bearing seat 6. A calibration beam 3 is connected to the detection roll 5 of the flatness meter through a calibration bracket 2. A calibration rod 8 is sleeved [uncertain as to meaning] on the calibration beam 3. The calibration rod 8 can move along the calibration beam 3 and be axially fixed at a predetermined position. A pressure roller 7 is mounted on the calibration rod 8. Due to gravity, a calibration weight 4 located at one end of the calibration rod 8, the pressure roller 7 rotates with the detection roll 5 toward each other, and generates a calibration force to the sensor 9 in the channel 11 of the detection roll 5. After the AD influence value of a channel 11 on itself and on an adjacent channel 11 is detected, the axial fixation of the calibration rod 8 can be released, and move above the other channels 11 to continue measurement.

TABLE 1
AD influence values between three
adjacent channels

| Channel | | | |
|---|---|---|---|
| Code | j = i − 1 | j = i | j = i + 1 |
| i = 1 | / | 14493 | 1483 |
| i = 2 | 1883 | 17335 | 2845 |
| i = 3 | 1902 | 15664 | 1933 |
| i = 4 | 1801 | 14771 | 2372 |
| i = 5 | 2048 | 14607 | 1415 |
| i = 6 | 1507 | 13070 | 2725 |
| i = 7 | 1716 | 14222 | 2261 |
| i = 8 | 1431 | 15523 | 2772 |
| i = 9 | 2280 | 14232 | 1992 |
| i = 10 | 1087 | 14429 | 3095 |
| i = 11 | 1598 | 16081 | 3022 |
| i = 12 | 1508 | 18166 | 2476 |
| i = 13 | 1844 | 13418 | 2007 |
| i = 14 | 1254 | 18842 | 3119 |
| i = 15 | 2602 | 15493 | 2499 |
| i = 16 | 1416 | 17296 | 2899 |
| i = 17 | 2099 | 15808 | 2777 |
| i = 18 | 1720 | 18319 | 2831 |
| i = 19 | 2003 | 15423 | 1886 |
| i = 20 | 1700 | 16667 | 2703 |
| i = 21 | 2173 | 16123 | 2471 |
| i = 22 | 1649 | 17347 | 2777 |
| i = 23 | 2219 | 14386 | 1994 |
| i = 24 | 1139 | 14060 | 3073 |
| i = 25 | 2006 | 16191 | 1938 |
| i = 26 | 1324 | 15200 | 1840 |
| i = 27 | 2193 | 15223 | 1927 |
| i = 28 | 1236 | 14861 | 2781 |
| i = 29 | 2024 | 16244 | 2118 |
| i = 30 | 1524 | 15839 | 2259 |
| i = 31 | 2093 | 16953 | 2677 |
| i = 32 | 1861 | 15714 | 2554 |
| i = 33 | 1885 | 16135 | 2283 |
| i = 34 | 2020 | 15232 | 1949 |
| i = 35 | 1823 | 16019 | 2272 |
| i = 36 | 1462 | 16275 | 2057 |
| i = 37 | 2400 | 15816 | 2355 |
| i = 38 | 1928 | 15556 | 2700 |
| i = 39 | 2225 | 15722 | 2050 |
| i = 40 | 1318 | 17950 | 2305 |
| i = 41 | 2347 | 15278 | 2216 |
| i = 42 | 1689 | 16916 | 3082 |
| i = 43 | 2613 | 17406 | 2142 |
| i = 44 | 1503 | 16887 | 2278 |
| i = 45 | 2057 | 18211 | 2275 |
| i = 46 | 2522 | 16718 | 2446 |
| i = 47 | 2245 | 19027 | 1925 |
| i = 48 | 2094 | 16642 | 1942 |
| i = 49 | 1927 | 16270 | 2747 |
| i = 50 | 1882 | 17667 | 2253 |
| i = 51 | 2060 | 16845 | 2282 |
| i = 52 | 1880 | 16463 | 2012 |
| i = S3 | 2460 | 14555 | 2006 |
| i = 54 | 987 | 15751 | 2170 |
| i = 55 | 2233 | 14410 | 2090 |
| i = 56 | 1253 | 16419 | 2741 |
| i = 57 | 2038 | 17689 | / |

Influence coefficients βⱼᵢ in the influence matrix are respectively calculated with the data of Table 1, as shown in Table 2 below. j is a row number of the matrix, also ranging from 1 to n, and i is a column number of the matrix, ranging from 1 to n. The influence coefficients in the influence matrix B̅ are all 0 except for those given in the table below.

TABLE 2
Influence coefficients βⱼᵢ in the influence matrix

| Channel | | | |
|---|---|---|---|
| Code | j = i − 1 | j = i | j = i + 1 |
| i = 1 | / | 1 | 0.0855 |
| i = 2 | 0.1299 | 1 | 0.1816 |
| i = 3 | 0.1097 | 1 | 0.1309 |
| i = 4 | 0.1150 | 1 | 0.1624 |
| i = 5 | 0.1387 | 1 | 0.1083 |
| i = 6 | 0.1032 | 1 | 0.1916 |
| i = 7 | 0.1313 | 1 | 0.1457 |
| i = 8 | 0.1006 | 1 | 0.1948 |
| i = 9 | 0.1469 | 1 | 0.1381 |
| i = 10 | 0.0764 | 1 | 0.1925 |
| i = 11 | 0.1107 | 1 | 0.1664 |
| i = 12 | 0.0938 | 1 | 0.1845 |
| i = 13 | 0.1015 | 1 | 0.1065 |
| i = 14 | 0.0935 | 1 | 0.2025 |

c, calculate an inverse matrix (B̅)⁻¹ of the influence matrix, where elements in columns 1 to 8 of (B̅)⁻¹ are shown in Table 3 below; j is a row number and i is a column number of the matrix.

TABLE 3
Elements in columns 1 to 8 of (B̅)⁻¹

| Column/ | | | | | | | | |
|---|---|---|---|---|---|---|---|---|
| Row | | | | | | | | |
| Number | i = 1 | i = 2 | i = 3 | i = 4 | i = 5 | i = 6 | i = 7 | i = 8 |
| j = 1 | 1.0115 | −0.1341 | 0.0149 | −0.0018 | 0.0002 | 0.0000 | 0.0000 | 0.0000 |
| j = 2 | −0.0883 | 1.0324 | −0.1150 | 0.0135 | −0.0019 | 0.0002 | 0.0000 | 0.0000 |
| j = 3 | 0.0163 | −0.1904 | 1.0369 | −0.1220 | 0.0171 | −0.0018 | 0.0002 | 0.0000 |
| j = 4 | −0.0022 | 0.0255 | −0.1389 | 1.0396 | −0.1458 | 0.0154 | −0.0021 | 0.0002 |
| j = 5 | 0.0004 | −0.0042 | 0.0228 | −0.1708 | 1.0355 | −0.1096 | 0.0146 | −0.0015 |
| j = 6 | 0.0000 | 0.0005 | −0.0025 | 0.0190 | −0.1151 | 1.0384 | −0.1384 | 0.0143 |
| j = 7 | 0.0000 | −0.0001 | 0.0005 | −0.0037 | 0.0224 | −0.2020 | 1.0423 | −0.1080 |
| j = 8 | 0.0000 | 0.0000 | −0.0001 | 0.0006 | −0.0034 | 0.0303 | −0.1563 | 1.0460 |
| j = 9 | 0.0000 | 0.0000 | 0.0000 | −0.0001 | 0.0007 | −0.0060 | 0.0308 | −0.2059 |
| j = 10 | 0.0000 | 0.0000 | 0.0000 | 0.0000 | −0.0001 | 0.0008 | −0.0043 | 0.0291 |
| j = 11 | 0.0000 | 0.0000 | 0.0000 | 0.0000 | 0.0000 | −0.0002 | 0.0008 | −0.0057 |
| j = 12 | 0.0000 | 0.0000 | 0.0000 | 0.0000 | 0.0000 | 0.0000 | −0.0001 | 0.0010 |
| j = 13 | 0.0000 | 0.0000 | 0.0000 | 0.0000 | 0.0000 | 0.0000 | 0.0000 | −0.0002 |
| j = 14 | 0.0000 | 0.0000 | 0.0000 | 0.0000 | 0.0000 | 0.0000 | 0.0000 | 0.0000 |
| j = 15 | 0.0000 | 0.0000 | 0.0000 | 0.0000 | 0.0000 | 0.0000 | 0.0000 | 0.0000 |
| j = 16 | 0.0000 | 0.0000 | 0.0000 | 0.0000 | 0.0000 | 0.0000 | 0.0000 | 0.0000 |
| j = 17 | 0.0000 | 0.0000 | 0.0000 | 0.0000 | 0.0000 | 0.0000 | 0.0000 | 0.0000 |
| j = 18 | 0.0000 | 0.0000 | 0.0000 | 0.0000 | 0.0000 | 0.0000 | 0.0000 | 0.0000 |
| j = 19 | 0.0000 | 0.0000 | 0.0000 | 0.0000 | 0.0000 | 0.0000 | 0.0000 | 0.0000 |
| j = 20 | 0.0000 | 0.0000 | 0.0000 | 0.0000 | 0.0000 | 0.0000 | 0.0000 | 0.0000 |
| j = 21 | 0.0000 | 0.0000 | 0.0000 | 0.0000 | 0.0000 | 0.0000 | 0.0000 | 0.0000 |
| j = 22 | 0.0000 | 0.0000 | 0.0000 | 0.0000 | 0.0000 | 0.0000 | 0.0000 | 0.0000 |
| j = 23 | 0.0000 | 0.0000 | 0.0000 | 0.0000 | 0.0000 | 0.0000 | 0.0000 | 0.0000 |
| j = 24 | 0.0000 | 0.0000 | 0.0000 | 0.0000 | 0.0000 | 0.0000 | 0.0000 | 0.0000 |
| j = 25 | 0.0000 | 0.0000 | 0.0000 | 0.0000 | 0.0000 | 0.0000 | 0.0000 | 0.0000 |
| j = 26 | 0.0000 | 0.0000 | 0.0000 | 0.0000 | 0.0000 | 0.0000 | 0.0000 | 0.0000 |
| j = 27 | 0.0000 | 0.0000 | 0.0000 | 0.0000 | 0.0000 | 0.0000 | 0.0000 | 0.0000 |
| j = 28 | 0.0000 | 0.0000 | 0.0000 | 0.0000 | 0.0000 | 0.0000 | 0.0000 | 0.0000 |
| j = 29 | 0.0000 | 0.0000 | 0.0000 | 0.0000 | 0.0000 | 0.0000 | 0.0000 | 0.0000 |
| j = 30 | 0.0000 | 0.0000 | 0.0000 | 0.0000 | 0.0000 | 0.0000 | 0.0000 | 0.0000 |
| j = 31 | 0.0000 | 0.0000 | 0.0000 | 0.0000 | 0.0000 | 0.0000 | 0.0000 | 0.0000 |
| j = 32 | 0.0000 | 0.0000 | 0.0000 | 0.0000 | 0.0000 | 0.0000 | 0.0000 | 0.0000 |
| j = 33 | 0.0000 | 0.0000 | 0.0000 | 0.0000 | 0.0000 | 0.0000 | 0.0000 | 0.0000 |
| j = 34 | 0.0000 | 0.0000 | 0.0000 | 0.0000 | 0.0000 | 0.0000 | 0.0000 | 0.0000 |
| j = 35 | 0.0000 | 0.0000 | 0.0000 | 0.0000 | 0.0000 | 0.0000 | 0.0000 | 0.0000 |
| j = 36 | 0.0000 | 0.0000 | 0.0000 | 0.0000 | 0.0000 | 0.0000 | 0.0000 | 0.0000 |
| j = 37 | 0.0000 | 0.0000 | 0.0000 | 0.0000 | 0.0000 | 0.0000 | 0.0000 | 0.0000 |
| j = 38 | 0.0000 | 0.0000 | 0.0000 | 0.0000 | 0.0000 | 0.0000 | 0.0000 | 0.0000 |
| j = 39 | 0.0000 | 0.0000 | 0.0000 | 0.0000 | 0.0000 | 0.0000 | 0.0000 | 0.0000 |
| j = 40 | 0.0000 | 0.0000 | 0.0000 | 0.0000 | 0.0000 | 0.0000 | 0.0000 | 0.0000 |
| j = 41 | 0.0000 | 0.0000 | 0.0000 | 0.0000 | 0.0000 | 0.0000 | 0.0000 | 0.0000 |
| j = 42 | 0.0000 | 0.0000 | 0.0000 | 0.0000 | 0.0000 | 0.0000 | 0.0000 | 0.0000 |
| j = 43 | 0.0000 | 0.0000 | 0.0000 | 0.0000 | 0.0000 | 0.0000 | 0.0000 | 0.0000 |
| j = 44 | 0.0000 | 0.0000 | 0.0000 | 0.0000 | 0.0000 | 0.0000 | 0.0000 | 0.0000 |
| j = 45 | 0.0000 | 0.0000 | 0.0000 | 0.0000 | 0.0000 | 0.0000 | 0.0000 | 0.0000 |
| j = 46 | 0.0000 | 0.0000 | 0.0000 | 0.0000 | 0.0000 | 0.0000 | 0.0000 | 0.0000 |
| j = 47 | 0.0000 | 0.0000 | 0.0000 | 0.0000 | 0.0000 | 0.0000 | 0.0000 | 0.0000 |
| j = 48 | 0.0000 | 0.0000 | 0.0000 | 0.0000 | 0.0000 | 0.0000 | 0.0000 | 0.0000 |
| j = 49 | 0.0000 | 0.0000 | 0.0000 | 0.0000 | 0.0000 | 0.0000 | 0.0000 | 0.0000 |
| j = 50 | 0.0000 | 0.0000 | 0.0000 | 0.0000 | 0.0000 | 0.0000 | 0.0000 | 0.0000 |
| j = 51 | 0.0000 | 0.0000 | 0.0000 | 0.0000 | 0.0000 | 0.0000 | 0.0000 | 0.0000 |
| j = 52 | 0.0000 | 0.0000 | 0.0000 | 0.0000 | 0.0000 | 0.0000 | 0.0000 | 0.0000 |
| j = 53 | 0.0000 | 0.0000 | 0.0000 | 0.0000 | 0.0000 | 0.0000 | 0.0000 | 0.0000 |
| j = 54 | 0.0000 | 0.0000 | 0.0000 | 0.0000 | 0.0000 | 0.0000 | 0.0000 | 0.0000 |
| j = 55 | 0.0000 | 0.0000 | 0.0000 | 0.0000 | 0.0000 | 0.0000 | 0.0000 | 0.0000 |
| j = 56 | 0.0000 | 0.0000 | 0.0000 | 0.0000 | 0.0000 | 0.0000 | 0.0000 | 0.0000 |
| j = 57 | 0.0000 | 0.0000 | 0.0000 | 0.0000 | 0.0000 | 0.0000 | 0.0000 | 0.0000 |

Elements in columns 9 to 16 of (B̅)⁻¹ are shown in Table 4 below

TABLE 4
Elements in columns 9 to 16 of (B̅)⁻¹

| Column/ | | | | | | | | |
|---|---|---|---|---|---|---|---|---|
| Row | | | | | | | | |
| Number | i = 9 | i = 10 | i = 11 | i = 12 | i = 13 | i = 14 | i = 15 | i = 16 |
| j = 1 | 0.0000 | 0.0000 | 0.0000 | 0.0000 | 0.0000 | 0.0000 | 0.0000 | 0.0000 |
| j = 2 | 0.0000 | 0.0000 | 0.0000 | 0.0000 | 0.0000 | 0.0000 | 0.0000 | 0.0000 |
| j = 3 | 0.0000 | 0.0000 | 0.0000 | 0.0000 | 0.0000 | 0.0000 | 0.0000 | 0.0000 |
| j = 4 | 0.0000 | 0.0000 | 0.0000 | 0.0000 | 0.0000 | 0.0000 | 0.0000 | 0.0000 |
| j = 5 | 0.0002 | 0.0000 | 0.0000 | 0.0000 | 0.0000 | 0.0000 | 0.0000 | 0.0000 |
| j = 6 | −0.0021 | 0.0002 | 0.0000 | 0.0000 | 0.0000 | 0.0000 | 0.0000 | 0.0000 |
| j = 7 | 0.0160 | −0.0013 | 0.0001 | 0.0000 | 0.0000 | 0.0000 | 0.0000 | 0.0000 |
| j = 8 | −0.1553 | 0.0121 | −0.0014 | 0.0001 | 0.0000 | 0.0000 | 0.0000 | 0.0000 |
| j = 9 | 1.0415 | −0.0813 | 0.0092 | −0.0009 | 0.0001 | 0.0000 | 0.0000 | 0.0000 |
| j = 10 | −0.1470 | 1.0336 | −0.1163 | 0.0111 | −0.0011 | 0.0001 | 0.0000 | 0.0000 |
| j = 11 | 0.0287 | −0.2021 | 1.0389 | −0.0993 | 0.0102 | −0.0010 | 0.0001 | 0.0000 |
| j = 12 | −0.0049 | 0.0343 | −0.1762 | 1.0361 | −0.1063 | 0.0102 | −0.0014 | 0.0001 |
| j = 13 | 0.0009 | −0.0064 | 0.0328 | −0.1932 | 1.0302 | −0.0991 | 0.0139 | −0.0013 |
| j = 14 | −0.0001 | 0.0007 | −0.0036 | 0.0212 | −0.1129 | 1.0400 | −0.1456 | 0.0137 |
| j = 15 | 0.0000 | −0.0001 | 0.0007 | −0.0043 | 0.0232 | −0.2135 | 1.0437 | −0.0982 |
| j = 16 | 0.0000 | 0.0000 | −0.0001 | 0.0006 | −0.0034 | 0.0316 | −0.1543 | 1.0377 |
| j = 17 | 0.0000 | 0.0000 | 0.0000 | −0.0001 | 0.0006 | −0.0059 | 0.0288 | −0.1936 |
| j = 18 | 0.0000 | 0.0000 | 0.0000 | 0.0000 | −0.0001 | 0.0009 | −0.0045 | 0.0300 |
| j = 19 | 0.0000 | 0.0000 | 0.0000 | 0.0000 | 0.0000 | −0.0002 | 0.0008 | −0.0056 |
| j = 20 | 0.0000 | 0.0000 | 0.0000 | 0.0000 | 0.0000 | 0.0000 | −0.0001 | 0.0006 |
| j = 21 | 0.0000 | 0.0000 | 0.0000 | 0.0000 | 0.0000 | 0.0000 | 0.0000 | −0.0001 |
| j = 22 | 0.0000 | 0.0000 | 0.0000 | 0.0000 | 0.0000 | 0.0000 | 0.0000 | 0.0000 |
| j = 23 | 0.0000 | 0.0000 | 0.0000 | 0.0000 | 0.0000 | 0.0000 | 0.0000 | 0.0000 |
| j = 24 | 0.0000 | 0.0000 | 0.0000 | 0.0000 | 0.0000 | 0.0000 | 0.0000 | 0.0000 |
| j = 25 | 0.0000 | 0.0000 | 0.0000 | 0.0000 | 0.0000 | 0.0000 | 0.0000 | 0.0000 |
| j = 26 | 0.0000 | 0.0000 | 0.0000 | 0.0000 | 0.0000 | 0.0000 | 0.0000 | 0.0000 |
| j = 27 | 0.0000 | 0.0000 | 0.0000 | 0.0000 | 0.0000 | 0.0000 | 0.0000 | 0.0000 |
| j = 28 | 0.0000 | 0.0000 | 0.0000 | 0.0000 | 0.0000 | 0.0000 | 0.0000 | 0.0000 |
| j = 29 | 0.0000 | 0.0000 | 0.0000 | 0.0000 | 0.0000 | 0.0000 | 0.0000 | 0.0000 |
| j = 30 | 0.0000 | 0.0000 | 0.0000 | 0.0000 | 0.0000 | 0.0000 | 0.0000 | 0.0000 |
| j = 31 | 0.0000 | 0.0000 | 0.0000 | 0.0000 | 0.0000 | 0.0000 | 0.0000 | 0.0000 |
| j = 32 | 0.0000 | 0.0000 | 0.0000 | 0.0000 | 0.0000 | 0.0000 | 0.0000 | 0.0000 |
| j = 33 | 0.0000 | 0.0000 | 0.0000 | 0.0000 | 0.0000 | 0.0000 | 0.0000 | 0.0000 |
| j = 34 | 0.0000 | 0.0000 | 0.0000 | 0.0000 | 0.0000 | 0.0000 | 0.0000 | 0.0000 |
| j = 35 | 0.0000 | 0.0000 | 0.0000 | 0.0000 | 0.0000 | 0.0000 | 0.0000 | 0.0000 |
| j = 36 | 0.0000 | 0.0000 | 0.0000 | 0.0000 | 0.0000 | 0.0000 | 0.0000 | 0.0000 |
| j = 37 | 0.0000 | 0.0000 | 0.0000 | 0.0000 | 0.0000 | 0.0000 | 0.0000 | 0.0000 |
| j = 38 | 0.0000 | 0.0000 | 0.0000 | 0.0000 | 0.0000 | 0.0000 | 0.0000 | 0.0000 |
| j = 39 | 0.0000 | 0.0000 | 0.0000 | 0.0000 | 0.0000 | 0.0000 | 0.0000 | 0.0000 |
| j = 40 | 0.0000 | 0.0000 | 0.0000 | 0.0000 | 0.0000 | 0.0000 | 0.0000 | 0.0000 |
| j = 41 | 0.0000 | 0.0000 | 0.0000 | 0.0000 | 0.0000 | 0.0000 | 0.0000 | 0.0000 |
| j = 42 | 0.0000 | 0.0000 | 0.0000 | 0.0000 | 0.0000 | 0.0000 | 0.0000 | 0.0000 |
| j = 43 | 0.0000 | 0.0000 | 0.0000 | 0.0000 | 0.0000 | 0.0000 | 0.0000 | 0.0000 |
| j = 44 | 0.0000 | 0.0000 | 0.0000 | 0.0000 | 0.0000 | 0.0000 | 0.0000 | 0.0000 |
| j = 45 | 0.0000 | 0.0000 | 0.0000 | 0.0000 | 0.0000 | 0.0000 | 0.0000 | 0.0000 |
| j = 46 | 0.0000 | 0.0000 | 0.0000 | 0.0000 | 0.0000 | 0.0000 | 0.0000 | 0.0000 |
| j = 47 | 0.0000 | 0.0000 | 0.0000 | 0.0000 | 0.0000 | 0.0000 | 0.0000 | 0.0000 |
| j = 48 | 0.0000 | 0.0000 | 0.0000 | 0.0000 | 0.0000 | 0.0000 | 0.0000 | 0.0000 |
| j = 49 | 0.0000 | 0.0000 | 0.0000 | 0.0000 | 0.0000 | 0.0000 | 0.0000 | 0.0000 |
| j = 50 | 0.0000 | 0.0000 | 0.0000 | 0.0000 | 0.0000 | 0.0000 | 0.0000 | 0.0000 |
| j = 51 | 0.0000 | 0.0000 | 0.0000 | 0.0000 | 0.0000 | 0.0000 | 0.0000 | 0.0000 |
| j = 52 | 0.0000 | 0.0000 | 0.0000 | 0.0000 | 0.0000 | 0.0000 | 0.0000 | 0.0000 |
| j = 53 | 0.0000 | 0.0000 | 0.0000 | 0.0000 | 0.0000 | 0.0000 | 0.0000 | 0.0000 |
| j = 54 | 0.0000 | 0.0000 | 0.0000 | 0.0000 | 0.0000 | 0.0000 | 0.0000 | 0.0000 |
| j = 55 | 0.0000 | 0.0000 | 0.0000 | 0.0000 | 0.0000 | 0.0000 | 0.0000 | 0.0000 |
| j = 56 | 0.0000 | 0.0000 | 0.0000 | 0.0000 | 0.0000 | 0.0000 | 0.0000 | 0.0000 |
| j = 57 | 0.0000 | 0.0000 | 0.0000 | 0.0000 | 0.0000 | 0.0000 | 0.0000 | 0.0000 |

Elements in columns 17 to 24 of (B̅)⁻¹ are shown in Table 5.

TABLE 5
Elements in columns 17 to 24 of (B̅)⁻¹

| Column/ | | | | | | | | |
|---|---|---|---|---|---|---|---|---|
| Row | | | | | | | | |
| Number | i = 17 | i = 18 | i = 19 | i = 20 | i = 21 | i = 22 | i = 23 | i = 24 |
| j = 1 | 0.0000 | 0.0000 | 0.0000 | 0.0000 | 0.0000 | 0.0000 | 0.0000 | 0.0000 |
| j = 2 | 0.0000 | 0.0000 | 0.0000 | 0.0000 | 0.0000 | 0.0000 | 0.0000 | 0.0000 |
| j = 3 | 0.0000 | 0.0000 | 0.0000 | 0.0000 | 0.0000 | 0.0000 | 0.0000 | 0.0000 |
| j = 4 | 0.0000 | 0.0000 | 0.0000 | 0.0000 | 0.0000 | 0.0000 | 0.0000 | 0.0000 |
| j = 5 | 0.0000 | 0.0000 | 0.0000 | 0.0000 | 0.0000 | 0.0000 | 0.0000 | 0.0000 |
| j = 6 | 0.0000 | 0.0000 | 0.0000 | 0.0000 | 0.0000 | 0.0000 | 0.0000 | 0.0000 |
| j = 7 | 0.0000 | 0.0000 | 0.0000 | 0.0000 | 0.0000 | 0.0000 | 0.0000 | 0.0000 |
| j = 8 | 0.0000 | 0.0000 | 0.0000 | 0.0000 | 0.0000 | 0.0000 | 0.0000 | 0.0000 |
| j = 9 | 0.0000 | 0.0000 | 0.0000 | 0.0000 | 0.0000 | 0.0000 | 0.0000 | 0.0000 |
| j = 10 | 0.0000 | 0.0000 | 0.0000 | 0.0000 | 0.0000 | 0.0000 | 0.0000 | 0.0000 |
| j = 11 | 0.0000 | 0.0000 | 0.0000 | 0.0000 | 0.0000 | 0.0000 | 0.0000 | 0.0000 |
| j = 12 | 0.0000 | 0.0000 | 0.0000 | 0.0000 | 0.0000 | 0.0000 | 0.0000 | 0.0000 |
| j = 13 | 0.0002 | 0.0000 | 0.0000 | 0.0000 | 0.0000 | 0.0000 | 0.0000 | 0.0000 |
| j = 14 | −0.0017 | 0.0002 | 0.0000 | 0.0000 | 0.0000 | 0.0000 | 0.0000 | 0.0000 |
| j = 15 | 0.0121 | −0.0013 | 0.0001 | 0.0000 | 0.0000 | 0.0000 | 0.0000 | 0.0000 |
| j = 16 | −0.1281 | 0.0142 | −0.0016 | 0.0002 | 0.0000 | 0.0000 | 0.0000 | 0.0000 |
| j = 17 | 1.0410 | −0.1156 | 0.0128 | −0.0014 | 0.0002 | 0.0000 | 0.0000 | 0.0000 |
| j = 18 | −0.1611 | 1.0386 | −0.1150 | 0.0130 | −0.0017 | 0.0002 | 0.0000 | 0.0000 |
| j = 19 | 0.0300 | −0.1931 | 1.0343 | −0.1166 | 0.0154 | −0.0016 | 0.0002 | 0.0000 |
| j = 20 | −0.0035 | 0.0223 | −0.1197 | 1.0362 | −0.1371 | 0.0144 | −0.0019 | 0.0002 |
| j = 21 | 0.0006 | −0.0038 | 0.0204 | −0.1764 | 1.0385 | −0.1089 | 0.0141 | −0.0011 |
| j = 22 | −0.0001 | 0.0006 | −0.0030 | 0.0258 | −0.1517 | 1.0415 | −0.1348 | 0.0110 |
| j = 23 | 0.0000 | −0.0001 | 0.0006 | −0.0050 | 0.0296 | −0.2034 | 1.0380 | −0.0845 |
| j = 24 | 0.0000 | 0.0000 | −0.0001 | 0.0007 | −0.0043 | 0.0297 | −0.1514 | 1.0405 |
| j = 25 | 0.0000 | 0.0000 | 0.0000 | −0.0001 | 0.0008 | −0.0057 | 0.0290 | −0.1996 |
| j = 26 | 0.0000 | 0.0000 | 0.0000 | 0.0000 | −0.0001 | 0.0007 | −0.0038 | 0.0259 |
| j = 27 | 0.0000 | 0.0000 | 0.0000 | 0.0000 | 0.0000 | −0.0001 | 0.0005 | −0.0032 |
| j = 28 | 0.0000 | 0.0000 | 0.0000 | 0.0000 | 0.0000 | 0.0000 | −0.0001 | 0.0004 |
| j = 29 | 0.0000 | 0.0000 | 0.0000 | 0.0000 | 0.0000 | 0.0000 | 0.0000 | −0.0001 |
| j = 30 | 0.0000 | 0.0000 | 0.0000 | 0.0000 | 0.0000 | 0.0000 | 0.0000 | 0.0000 |
| j = 31 | 0.0000 | 0.0000 | 0.0000 | 0.0000 | 0.0000 | 0.0000 | 0.0000 | 0.0000 |
| j = 32 | 0.0000 | 0.0000 | 0.0000 | 0.0000 | 0.0000 | 0.0000 | 0.0000 | 0.0000 |
| j = 33 | 0.0000 | 0.0000 | 0.0000 | 0.0000 | 0.0000 | 0.0000 | 0.0000 | 0.0000 |
| j = 34 | 0.0000 | 0.0000 | 0.0000 | 0.0000 | 0.0000 | 0.0000 | 0.0000 | 0.0000 |
| j = 35 | 0.0000 | 0.0000 | 0.0000 | 0.0000 | 0.0000 | 0.0000 | 0.0000 | 0.0000 |
| j = 36 | 0.0000 | 0.0000 | 0.0000 | 0.0000 | 0.0000 | 0.0000 | 0.0000 | 0.0000 |
| j = 37 | 0.0000 | 0.0000 | 0.0000 | 0.0000 | 0.0000 | 0.0000 | 0.0000 | 0.0000 |
| j = 38 | 0.0000 | 0.0000 | 0.0000 | 0.0000 | 0.0000 | 0.0000 | 0.0000 | 0.0000 |
| j = 39 | 0.0000 | 0.0000 | 0.0000 | 0.0000 | 0.0000 | 0.0000 | 0.0000 | 0.0000 |
| j = 40 | 0.0000 | 0.0000 | 0.0000 | 0.0000 | 0.0000 | 0.0000 | 0.0000 | 0.0000 |
| j = 41 | 0.0000 | 0.0000 | 0.0000 | 0.0000 | 0.0000 | 0.0000 | 0.0000 | 0.0000 |
| j = 42 | 0.0000 | 0.0000 | 0.0000 | 0.0000 | 0.0000 | 0.0000 | 0.0000 | 0.0000 |
| j = 43 | 0.0000 | 0.0000 | 0.0000 | 0.0000 | 0.0000 | 0.0000 | 0.0000 | 0.0000 |
| j = 44 | 0.0000 | 0.0000 | 0.0000 | 0.0000 | 0.0000 | 0.0000 | 0.0000 | 0.0000 |
| j = 45 | 0.0000 | 0.0000 | 0.0000 | 0.0000 | 0.0000 | 0.0000 | 0.0000 | 0.0000 |
| j = 46 | 0.0000 | 0.0000 | 0.0000 | 0.0000 | 0.0000 | 0.0000 | 0.0000 | 0.0000 |
| j = 47 | 0.0000 | 0.0000 | 0.0000 | 0.0000 | 0.0000 | 0.0000 | 0.0000 | 0.0000 |
| j = 48 | 0.0000 | 0.0000 | 0.0000 | 0.0000 | 0.0000 | 0.0000 | 0.0000 | 0.0000 |
| j = 49 | 0.0000 | 0.0000 | 0.0000 | 0.0000 | 0.0000 | 0.0000 | 0.0000 | 0.0000 |
| j = 50 | 0.0000 | 0.0000 | 0.0000 | 0.0000 | 0.0000 | 0.0000 | 0.0000 | 0.0000 |
| j = 51 | 0.0000 | 0.0000 | 0.0000 | 0.0000 | 0.0000 | 0.0000 | 0.0000 | 0.0000 |
| j = 52 | 0.0000 | 0.0000 | 0.0000 | 0.0000 | 0.0000 | 0.0000 | 0.0000 | 0.0000 |
| j = 53 | 0.0000 | 0.0000 | 0.0000 | 0.0000 | 0.0000 | 0.0000 | 0.0000 | 0.0000 |
| j = 54 | 0.0000 | 0.0000 | 0.0000 | 0.0000 | 0.0000 | 0.0000 | 0.0000 | 0.0000 |
| j = 55 | 0.0000 | 0.0000 | 0.0000 | 0.0000 | 0.0000 | 0.0000 | 0.0000 | 0.0000 |
| j = 56 | 0.0000 | 0.0000 | 0.0000 | 0.0000 | 0.0000 | 0.0000 | 0.0000 | 0.0000 |
| j = 57 | 0.0000 | 0.0000 | 0.0000 | 0.0000 | 0.0000 | 0.0000 | 0.0000 | 0.0000 |

Elements in columns 25 to 32 of (B̅)⁻¹ are shown in Table 6 below

TABLE 6
Elements in columns 25 to 32 of (B̅)⁻¹

| Column/ | | | | | | | | |
|---|---|---|---|---|---|---|---|---|
| Row | | | | | | | | |
| Number | i = 25 | i = 26 | i = 27 | i = 28 | i = 29 | i = 30 | i = 31 | i = 32 |
| j = 1 | 0.0000 | 0.0000 | 0.0000 | 0.0000 | 0.0000 | 0.0000 | 0.0000 | 0.0000 |
| j = 2 | 0.0000 | 0.0000 | 0.0000 | 0.0000 | 0.0000 | 0.0000 | 0.0000 | 0.0000 |
| j = 3 | 0.0000 | 0.0000 | 0.0000 | 0.0000 | 0.0000 | 0.0000 | 0.0000 | 0.0000 |
| j = 4 | 0.0000 | 0.0000 | 0.0000 | 0.0000 | 0.0000 | 0.0000 | 0.0000 | 0.0000 |
| j = 5 | 0.0000 | 0.0000 | 0.0000 | 0.0000 | 0.0000 | 0.0000 | 0.0000 | 0.0000 |
| j = 6 | 0.0000 | 0.0000 | 0.0000 | 0.0000 | 0.0000 | 0.0000 | 0.0000 | 0.0000 |
| j = 7 | 0.0000 | 0.0000 | 0.0000 | 0.0000 | 0.0000 | 0.0000 | 0.0000 | 0.0000 |
| j = 8 | 0.0000 | 0.0000 | 0.0000 | 0.0000 | 0.0000 | 0.0000 | 0.0000 | 0.0000 |
| j = 9 | 0.0000 | 0.0000 | 0.0000 | 0.0000 | 0.0000 | 0.0000 | 0.0000 | 0.0000 |
| j = 10 | 0.0000 | 0.0000 | 0.0000 | 0.0000 | 0.0000 | 0.0000 | 0.0000 | 0.0000 |
| j = 11 | 0.0000 | 0.0000 | 0.0000 | 0.0000 | 0.0000 | 0.0000 | 0.0000 | 0.0000 |
| j = 12 | 0.0000 | 0.0000 | 0.0000 | 0.0000 | 0.0000 | 0.0000 | 0.0000 | 0.0000 |
| j = 13 | 0.0000 | 0.0000 | 0.0000 | 0.0000 | 0.0000 | 0.0000 | 0.0000 | 0.0000 |
| j = 14 | 0.0000 | 0.0000 | 0.0000 | 0.0000 | 0.0000 | 0.0000 | 0.0000 | 0.0000 |
| j = 15 | 0.0000 | 0.0000 | 0.0000 | 0.0000 | 0.0000 | 0.0000 | 0.0000 | 0.0000 |
| j = 16 | 0.0000 | 0.0000 | 0.0000 | 0.0000 | 0.0000 | 0.0000 | 0.0000 | 0.0000 |
| j = 17 | 0.0000 | 0.0000 | 0.0000 | 0.0000 | 0.0000 | 0.0000 | 0.0000 | 0.0000 |
| j = 18 | 0.0000 | 0.0000 | 0.0000 | 0.0000 | 0.0000 | 0.0000 | 0.0000 | 0.0000 |
| j = 19 | 0.0000 | 0.0000 | 0.0000 | 0.0000 | 0.0000 | 0.0000 | 0.0000 | 0.0000 |
| j = 20 | 0.0000 | 0.0000 | 0.0000 | 0.0000 | 0.0000 | 0.0000 | 0.0000 | 0.0000 |
| j = 21 | 0.0002 | 0.0000 | 0.0000 | 0.0000 | 0.0000 | 0.0000 | 0.0000 | 0.0000 |
| j = 22 | −0.0016 | 0.0001 | 0.0000 | 0.0000 | 0.0000 | 0.0000 | 0.0000 | 0.0000 |
| j = 23 | 0.0122 | −0.0010 | 0.0001 | 0.0000 | 0.0000 | 0.0000 | 0.0000 | 0.0000 |
| j = 24 | −0.1500 | 0.0125 | −0.0018 | 0.0002 | 0.0000 | 0.0000 | 0.0000 | 0.0000 |
| j = 25 | 1.0395 | −0.0865 | 0.0126 | −0.0010 | 0.0001 | 0.0000 | 0.0000 | 0.0000 |
| j = 26 | −0.1349 | 1.0292 | −0.1501 | 0.0125 | −0.0017 | 0.0002 | 0.0000 | 0.0000 |
| j = 27 | 0.0165 | −0.1258 | 1.0292 | −0.0856 | −0.1429 | 0.0136 | −0.0018 | 0.0002 |
| j = 28 | −0.0022 | 0.0167 | −0.1367 | 1.0356 | −0.1429 | 0.0136 | −0.0018 | 0.0002 |
| j = 29 | 0.0004 | −0.0029 | 0.0237 | −0.1796 | 1.0377 | −0.0991 | 0.0134 | −0.0015 |
| j = 30 | −0.0001 | 0.0004 | −0.0032 | 0.0245 | −0.1413 | 1.0318 | −0.1390 | 0.0156 |
| j = 31 | 0.0000 | −0.0001 | 0.0004 | −0.0033 | 0.0192 | −0.1402 | 1.0383 | −0.1162 |
| j = 32 | 0.0000 | 0.0000 | −0.0001 | 0.0006 | −0.0033 | 0.0243 | −0.1804 | 1.0399 |
| j = 33 | 0.0000 | 0.0000 | 0.0000 | −0.0001 | 0.0005 | −0.0039 | 0.0291 | −0.1678 |
| j = 34 | 0.0000 | 0.0000 | 0.0000 | 0.0000 | −0.0001 | 0.0006 | −0.0044 | 0.0255 |
| j = 35 | 0.0000 | 0.0000 | 0.0000 | 0.0000 | 0.0000 | −0.0001 | 0.0005 | −0.0031 |
| j = 36 | 0.0000 | 0.0000 | 0.0000 | 0.0000 | 0.0000 | 0.0000 | −0.0001 | 0.0004 |
| j = 37 | 0.0000 | 0.0000 | 0.0000 | 0.0000 | 0.0000 | 0.0000 | 0.0000 | −0.0001 |
| j = 38 | 0.0000 | 0.0000 | 0.0000 | 0.0000 | 0.0000 | 0.0000 | 0.0000 | 0.0000 |
| j = 39 | 0.0000 | 0.0000 | 0.0000 | 0.0000 | 0.0000 | 0.0000 | 0.0000 | 0.0000 |
| j = 40 | 0.0000 | 0.0000 | 0.0000 | 0.0000 | 0.0000 | 0.0000 | 0.0000 | 0.0000 |
| j = 41 | 0.0000 | 0.0000 | 0.0000 | 0.0000 | 0.0000 | 0.0000 | 0.0000 | 0.0000 |
| j = 42 | 0.0000 | 0.0000 | 0.0000 | 0.0000 | 0.0000 | 0.0000 | 0.0000 | 0.0000 |
| j = 43 | 0.0000 | 0.0000 | 0.0000 | 0.0000 | 0.0000 | 0.0000 | 0.0000 | 0.0000 |
| j = 44 | 0.0000 | 0.0000 | 0.0000 | 0.0000 | 0.0000 | 0.0000 | 0.0000 | 0.0000 |
| j = 45 | 0.0000 | 0.0000 | 0.0000 | 0.0000 | 0.0000 | 0.0000 | 0.0000 | 0.0000 |
| j = 46 | 0.0000 | 0.0000 | 0.0000 | 0.0000 | 0.0000 | 0.0000 | 0.0000 | 0.0000 |
| j = 47 | 0.0000 | 0.0000 | 0.0000 | 0.0000 | 0.0000 | 0.0000 | 0.0000 | 0.0000 |
| j = 48 | 0.0000 | 0.0000 | 0.0000 | 0.0000 | 0.0000 | 0.0000 | 0.0000 | 0.0000 |
| j = 49 | 0.0000 | 0.0000 | 0.0000 | 0.0000 | 0.0000 | 0.0000 | 0.0000 | 0.0000 |
| j = 50 | 0.0000 | 0.0000 | 0.0000 | 0.0000 | 0.0000 | 0.0000 | 0.0000 | 0.0000 |
| j = 51 | 0.0000 | 0.0000 | 0.0000 | 0.0000 | 0.0000 | 0.0000 | 0.0000 | 0.0000 |
| j = 52 | 0.0000 | 0.0000 | 0.0000 | 0.0000 | 0.0000 | 0.0000 | 0.0000 | 0.0000 |
| j = 53 | 0.0000 | 0.0000 | 0.0000 | 0.0000 | 0.0000 | 0.0000 | 0.0000 | 0.0000 |
| j = 54 | 0.0000 | 0.0000 | 0.0000 | 0.0000 | 0.0000 | 0.0000 | 0.0000 | 0.0000 |
| j = 55 | 0.0000 | 0.0000 | 0.0000 | 0.0000 | 0.0000 | 0.0000 | 0.0000 | 0.0000 |
| j = 56 | 0.0000 | 0.0000 | 0.0000 | 0.0000 | 0.0000 | 0.0000 | 0.0000 | 0.0000 |
| j = 57 | 0.0000 | 0.0000 | 0.0000 | 0.0000 | 0.0000 | 0.0000 | 0.0000 | 0.0000 |

Elements in columns 33 to 40 of (B̅)⁻¹ are shown in Table 7.

TABLE 7
Elements in columns 33 to 40 of (B̅)⁻¹

| Column/ | | | | | | | | |
|---|---|---|---|---|---|---|---|---|
| Row | | | | | | | | |
| Number | i = 33 | i = 34 | i = 35 | i = 36 | i = 37 | i = 38 | i = 39 | i = 40 |
| j = 1 | 0.0000 | 0.0000 | 0.0000 | 0.0000 | 0.0000 | 0.0000 | 0.0000 | 0.0000 |
| j = 2 | 0.0000 | 0.0000 | 0.0000 | 0.0000 | 0.0000 | 0.0000 | 0.0000 | 0.0000 |
| j = 3 | 0.0000 | 0.0000 | 0.0000 | 0.0000 | 0.0000 | 0.0000 | 0.0000 | 0.0000 |
| j = 4 | 0.0000 | 0.0000 | 0.0000 | 0.0000 | 0.0000 | 0.0000 | 0.0000 | 0.0000 |
| j = 5 | 0.0000 | 0.0000 | 0.0000 | 0.0000 | 0.0000 | 0.0000 | 0.0000 | 0.0000 |
| j = 6 | 0.0000 | 0.0000 | 0.0000 | 0.0000 | 0.0000 | 0.0000 | 0.0000 | 0.0000 |
| j = 7 | 0.0000 | 0.0000 | 0.0000 | 0.0000 | 0.0000 | 0.0000 | 0.0000 | 0.0000 |
| j = 8 | 0.0000 | 0.0000 | 0.0000 | 0.0000 | 0.0000 | 0.0000 | 0.0000 | 0.0000 |
| j = 9 | 0.0000 | 0.0000 | 0.0000 | 0.0000 | 0.0000 | 0.0000 | 0.0000 | 0.0000 |
| j = 10 | 0.0000 | 0.0000 | 0.0000 | 0.0000 | 0.0000 | 0.0000 | 0.0000 | 0.0000 |
| j = 11 | 0.0000 | 0.0000 | 0.0000 | 0.0000 | 0.0000 | 0.0000 | 0.0000 | 0.0000 |
| j = 12 | 0.0000 | 0.0000 | 0.0000 | 0.0000 | 0.0000 | 0.0000 | 0.0000 | 0.0000 |
| j = 13 | 0.0000 | 0.0000 | 0.0000 | 0.0000 | 0.0000 | 0.0000 | 0.0000 | 0.0000 |
| j = 14 | 0.0000 | 0.0000 | 0.0000 | 0.0000 | 0.0000 | 0.0000 | 0.0000 | 0.0000 |
| j = 15 | 0.0000 | 0.0000 | 0.0000 | 0.0000 | 0.0000 | 0.0000 | 0.0000 | 0.0000 |
| j = 16 | 0.0000 | 0.0000 | 0.0000 | 0.0000 | 0.0000 | 0.0000 | 0.0000 | 0.0000 |
| j = 17 | 0.0000 | 0.0000 | 0.0000 | 0.0000 | 0.0000 | 0.0000 | 0.0000 | 0.0000 |
| j = 18 | 0.0000 | 0.0000 | 0.0000 | 0.0000 | 0.0000 | 0.0000 | 0.0000 | 0.0000 |
| j = 19 | 0.0000 | 0.0000 | 0.0000 | 0.0000 | 0.0000 | 0.0000 | 0.0000 | 0.0000 |
| j = 20 | 0.0000 | 0.0000 | 0.0000 | 0.0000 | 0.0000 | 0.0000 | 0.0000 | 0.0000 |
| j = 21 | 0.0000 | 0.0000 | 0.0000 | 0.0000 | 0.0000 | 0.0000 | 0.0000 | 0.0000 |
| j = 22 | 0.0000 | 0.0000 | 0.0000 | 0.0000 | 0.0000 | 0.0000 | 0.0000 | 0.0000 |
| j = 23 | 0.0000 | 0.0000 | 0.0000 | 0.0000 | 0.0000 | 0.0000 | 0.0000 | 0.0000 |
| j = 24 | 0.0000 | 0.0000 | 0.0000 | 0.0000 | 0.0000 | 0.0000 | 0.0000 | 0.0000 |
| j = 25 | 0.0000 | 0.0000 | 0.0000 | 0.0000 | 0.0000 | 0.0000 | 0.0000 | 0.0000 |
| j = 26 | 0.0000 | 0.0000 | 0.0000 | 0.0000 | 0.0000 | 0.0000 | 0.0000 | 0.0000 |
| j = 27 | 0.0000 | 0.0000 | 0.0000 | 0.0000 | 0.0000 | 0.0000 | 0.0000 | 0.0000 |
| j = 28 | 0.0000 | 0.0000 | 0.0000 | 0.0000 | 0.0000 | 0.0000 | 0.0000 | 0.0000 |
| j = 29 | 0.0002 | 0.0000 | 0.0000 | 0.0000 | 0.0000 | 0.0000 | 0.0000 | 0.0000 |
| j = 30 | −0.0019 | 0.0002 | 0.0000 | 0.0000 | 0.0000 | 0.0000 | 0.0000 | 0.0000 |
| j = 31 | 0.0142 | −0.0018 | 0.0002 | 0.0000 | 0.0000 | 0.0000 | 0.0000 | 0.0000 |
| j = 32 | −0.1272 | 0.0162 | −0.0020 | 0.0002 | 0.0000 | 0.0000 | 0.0000 | 0.0000 |
| j = 33 | 1.0399 | −0.1321 | 0.0160 | −0.0015 | 0.0002 | 0.0000 | 0.0000 | 0.0000 |
| j = 34 | −0.1582 | 1.0351 | −0.1255 | 0.0117 | −0.0018 | 0.0002 | 0.0000 | 0.0000 |
| j = 35 | 0.0195 | −0.1276 | 1.0286 | −0.0958 | 0.0144 | −0.0018 | 0.0003 | 0.0000 |
| j = 36 | −0.0028 | 0.0182 | −0.1465 | 1.0336 | −0.1554 | 0.0194 | −0.0028 | 0.0002 |
| j = 37 | 0.0004 | −0.0024 | 0.0194 | −0.1370 | 1.0399 | −0.1300 | 0.0188 | −0.0016 |
| j = 38 | −0.0001 | 0.0004 | −0.0030 | 0.0213 | −0.1614 | 1.0456 | −0.1510 | 0.0129 |
| j = 39 | 0.0000 | −0.0001 | 0.0005 | −0.0037 | 0.0280 | −0.1813 | 1.0361 | −0.0886 |
| j = 40 | 0.0000 | 0.0000 | −0.0001 | 0.0004 | −0.0033 | 0.0211 | −0.1207 | 1.0308 |
| j = 41 | 0.0000 | 0.0000 | 0.0000 | −0.0001 | 0.0005 | −0.0032 | 0.0185 | −0.1579 |
| j = 42 | 0.0000 | 0.0000 | 0.0000 | 0.0000 | −0.0001 | 0.0004 | −0.0025 | 0.0213 |
| j = 43 | 0.0000 | 0.0000 | 0.0000 | 0.0000 | 0.0000 | −0.0001 | 0.0004 | −0.0028 |
| j = 44 | 0.0000 | 0.0000 | 0.0000 | 0.0000 | 0.0000 | 0.0000 | −0.0001 | 0.0005 |
| j = 45 | 0.0000 | 0.0000 | 0.0000 | 0.0000 | 0.0000 | 0.0000 | 0.0000 | −0.0001 |
| j = 46 | 0.0000 | 0.0000 | 0.0000 | 0.0000 | 0.0000 | 0.0000 | 0.0000 | 0.0000 |
| j = 47 | 0.0000 | 0.0000 | 0.0000 | 0.0000 | 0.0000 | 0.0000 | 0.0000 | 0.0000 |
| j = 48 | 0.0000 | 0.0000 | 0.0000 | 0.0000 | 0.0000 | 0.0000 | 0.0000 | 0.0000 |
| j = 49 | 0.0000 | 0.0000 | 0.0000 | 0.0000 | 0.0000 | 0.0000 | 0.0000 | 0.0000 |
| j = 50 | 0.0000 | 0.0000 | 0.0000 | 0.0000 | 0.0000 | 0.0000 | 0.0000 | 0.0000 |
| j = 51 | 0.0000 | 0.0000 | 0.0000 | 0.0000 | 0.0000 | 0.0000 | 0.0000 | 0.0000 |
| j = 52 | 0.0000 | 0.0000 | 0.0000 | 0.0000 | 0.0000 | 0.0000 | 0.0000 | 0.0000 |
| j = 53 | 0.0000 | 0.0000 | 0.0000 | 0.0000 | 0.0000 | 0.0000 | 0.0000 | 0.0000 |
| j = 54 | 0.0000 | 0.0000 | 0.0000 | 0.0000 | 0.0000 | 0.0000 | 0.0000 | 0.0000 |
| j = 55 | 0.0000 | 0.0000 | 0.0000 | 0.0000 | 0.0000 | 0.0000 | 0.0000 | 0.0000 |
| j = 56 | 0.0000 | 0.0000 | 0.0000 | 0.0000 | 0.0000 | 0.0000 | 0.0000 | 0.0000 |
| j = 57 | 0.0000 | 0.0000 | 0.0000 | 0.0000 | 0.0000 | 0.0000 | 0.0000 | 0.0000 |

Elements in columns 41 to 48 of (B̅)⁻¹ are shown in Table 8.

TABLE 8
Elements in columns 41 to 48 of (B̅)⁻¹

| Column/ | | | | | | | | |
|---|---|---|---|---|---|---|---|---|
| Row | | | | | | | | |
| Number | i = 41 | i = 42 | i = 43 | i = 44 | i = 48 | i = 46 | i = 47 | i = 48 |
| j = 1 | 0.0000 | 0.0000 | 0.0000 | 0.0000 | 0.0000 | 0.0000 | 0.0000 | 0.0000 |
| j = 2 | 0.0000 | 0.0000 | 0.0000 | 0.0000 | 0.0000 | 0.0000 | 0.0000 | 0.0000 |
| j = 3 | 0.0000 | 0.0000 | 0.0000 | 0.0000 | 0.0000 | 0.0000 | 0.0000 | 0.0000 |
| j = 4 | 0.0000 | 0.0000 | 0.0000 | 0.0000 | 0.0000 | 0.0000 | 0.0000 | 0.0000 |
| j = 5 | 0.0000 | 0.0000 | 0.0000 | 0.0000 | 0.0000 | 0.0000 | 0.0000 | 0.0000 |
| j = 6 | 0.0000 | 0.0000 | 0.0000 | 0.0000 | 0.0000 | 0.0000 | 0.0000 | 0.0000 |
| j = 7 | 0.0000 | 0.0000 | 0.0000 | 0.0000 | 0.0000 | 0.0000 | 0.0000 | 0.0000 |
| j = 8 | 0.0000 | 0.0000 | 0.0000 | 0.0000 | 0.0000 | 0.0000 | 0.0000 | 0.0000 |
| j = 9 | 0.0000 | 0.0000 | 0.0000 | 0.0000 | 0.0000 | 0.0000 | 0.0000 | 0.0000 |
| j = 10 | 0.0000 | 0.0000 | 0.0000 | 0.0000 | 0.0000 | 0.0000 | 0.0000 | 0.0000 |
| j = 11 | 0.0000 | 0.0000 | 0.0000 | 0.0000 | 0.0000 | 0.0000 | 0.0000 | 0.0000 |
| j = 12 | 0.0000 | 0.0000 | 0.0000 | 0.0000 | 0.0000 | 0.0000 | 0.0000 | 0.0000 |
| j = 13 | 0.0000 | 0.0000 | 0.0000 | 0.0000 | 0.0000 | 0.0000 | 0.0000 | 0.0000 |
| j = 14 | 0.0000 | 0.0000 | 0.0000 | 0.0000 | 0.0000 | 0.0000 | 0.0000 | 0.0000 |
| j = 15 | 0.0000 | 0.0000 | 0.0000 | 0.0000 | 0.0000 | 0.0000 | 0.0000 | 0.0000 |
| j = 16 | 0.0000 | 0.0000 | 0.0000 | 0.0000 | 0.0000 | 0.0000 | 0.0000 | 0.0000 |
| j = 17 | 0.0000 | 0.0000 | 0.0000 | 0.0000 | 0.0000 | 0.0000 | 0.0000 | 0.0000 |
| j = 18 | 0.0000 | 0.0000 | 0.0000 | 0.0000 | 0.0000 | 0.0000 | 0.0000 | 0.0000 |
| j = 19 | 0.0000 | 0.0000 | 0.0000 | 0.0000 | 0.0000 | 0.0000 | 0.0000 | 0.0000 |
| j = 20 | 0.0000 | 0.0000 | 0.0000 | 0.0000 | 0.0000 | 0.0000 | 0.0000 | 0.0000 |
| j = 21 | 0.0000 | 0.0000 | 0.0000 | 0.0000 | 0.0000 | 0.0000 | 0.0000 | 0.0000 |
| j = 22 | 0.0000 | 0.0000 | 0.0000 | 0.0000 | 0.0000 | 0.0000 | 0.0000 | 0.0000 |
| j = 23 | 0.0000 | 0.0000 | 0.0000 | 0.0000 | 0.0000 | 0.0000 | 0.0000 | 0.0000 |
| j = 24 | 0.0000 | 0.0000 | 0.0000 | 0.0000 | 0.0000 | 0.0000 | 0.0000 | 0.0000 |
| j = 25 | 0.0000 | 0.0000 | 0.0000 | 0.0000 | 0.0000 | 0.0000 | 0.0000 | 0.0000 |
| j = 26 | 0.0000 | 0.0000 | 0.0000 | 0.0000 | 0.0000 | 0.0000 | 0.0000 | 0.0000 |
| j = 27 | 0.0000 | 0.0000 | 0.0000 | 0.0000 | 0.0000 | 0.0000 | 0.0000 | 0.0000 |
| j = 28 | 0.0000 | 0.0000 | 0.0000 | 0.0000 | 0.0000 | 0.0000 | 0.0000 | 0.0000 |
| j = 29 | 0.0000 | 0.0000 | 0.0000 | 0.0000 | 0.0000 | 0.0000 | 0.0000 | 0.0000 |
| j = 30 | 0.0000 | 0.0000 | 0.0000 | 0.0000 | 0.0000 | 0.0000 | 0.0000 | 0.0000 |
| j = 31 | 0.0000 | 0.0000 | 0.0000 | 0.0000 | 0.0000 | 0.0000 | 0.0000 | 0.0000 |
| j = 32 | 0.0000 | 0.0000 | 0.0000 | 0.0000 | 0.0000 | 0.0000 | 0.0000 | 0.0000 |
| j = 33 | 0.0000 | 0.0000 | 0.0000 | 0.0000 | 0.0000 | 0.0000 | 0.0000 | 0.0000 |
| j = 34 | 0.0000 | 0.0000 | 0.0000 | 0.0000 | 0.0000 | 0.0000 | 0.0000 | 0.0000 |
| j = 35 | 0.0000 | 0.0000 | 0.0000 | 0.0000 | 0.0000 | 0.0000 | 0.0000 | 0.0000 |
| j = 36 | 0.0000 | 0.0000 | 0.0000 | 0.0000 | 0.0000 | 0.0000 | 0.0000 | 0.0000 |
| j = 37 | 0.0002 | 0.0000 | 0.0000 | 0.0000 | 0.0000 | 0.0000 | 0.0000 | 0.0000 |
| j = 38 | −0.0017 | 0.0002 | 0.0000 | 0.0000 | 0.0000 | 0.0000 | 0.0000 | 0.0000 |
| j = 39 | 0.0118 | −0.0013 | 0.0002 | 0.0000 | 0.0000 | 0.0000 | 0.0000 | 0.0000 |
| j = 40 | −0.1368 | 0.0156 | −0.0024 | 0.0002 | 0.0000 | 0.0000 | 0.0000 | 0.0000 |
| j = 41 | 1.0361 | −0.1178 | 0.0184 | −0.0016 | 0.0002 | 0.0000 | 0.0000 | 0.0000 |
| j = 42 | −0.1396 | 1.0443 | −0.1631 | 0.0143 | −0.0018 | 0.0003 | 0.0000 | 0.0000 |
| j = 43 | 0.0250 | −0.1870 | 1.0405 | −0.0913 | 0.0113 | −0.0016 | 0.0002 | 0.0000 |
| j = 44 | −0.0032 | 0.0241 | −0.1341 | 1.0275 | −0.1276 | 0.0180 | −0.0024 | 0.0003 |
| j = 45 | 0.0004 | −0.0031 | 0.0171 | −0.1310 | 1.0358 | −0.1460 | 0.0199 | −0.0022 |
| j = 46 | −0.0001 | 0.0004 | −0.0024 | 0.0182 | −0.1435 | 1.0380 | −0.1412 | 0.0158 |
| j = 47 | 0.0000 | −0.0001 | 0.0003 | −0.0024 | 0.0187 | −0.1352 | 1.0315 | −0.1151 |
| j = 48 | 0.0000 | 0.0000 | 0.0000 | 0.0003 | −0.0022 | 0.0159 | −0.1210 | 1.0278 |
| j = 49 | 0.0000 | 0.0000 | 0.0000 | 0.0000 | 0.0003 | −0.0019 | 0.0147 | −0.1250 |
| j = 50 | 0.0000 | 0.0000 | 0.0000 | 0.0000 | 0.0000 | 0.0003 | −0.0023 | 0.0197 |
| j = 51 | 0.0000 | 0.0000 | 0.0000 | 0.0000 | 0.0000 | 0.0000 | 0.0003 | −0.0027 |
| j = 52 | 0.0000 | 0.0000 | 0.0000 | 0.0000 | 0.0000 | 0.0000 | 0.0000 | 0.0004 |
| j = 53 | 0.0000 | 0.0000 | 0.0000 | 0.0000 | 0.0000 | 0.0000 | 0.0000 | −0.0001 |
| j = 54 | 0.0000 | 0.0000 | 0.0000 | 0.0000 | 0.0000 | 0.0000 | 0.0000 | 0.0000 |
| j = 55 | 0.0000 | 0.0000 | 0.0000 | 0.0000 | 0.0000 | 0.0000 | 0.0000 | 0.0000 |
| j = 56 | 0.0000 | 0.0000 | 0.0000 | 0.0000 | 0.0000 | 0.0000 | 0.0000 | 0.0000 |
| j = 57 | 0.0000 | 0.0000 | 0.0000 | 0.0000 | 0.0000 | 0.0000 | 0.0000 | 0.0000 |

Elements in columns 49 to 56 of (B̅)⁻¹ are shown in Table 9.

TABLE 9
Elements in columns 49 to 56 of (B̅)⁻¹

| Column/ | | | | | | | | |
|---|---|---|---|---|---|---|---|---|
| Row | | | | | | | | |
| Number | i = 49 | i = 50 | i = 51 | i = 52 | i = 53 | i = 54 | i = 55 | i = 56 |
| j = 1 | 0.0000 | 0.0000 | 0.0000 | 0.0000 | 0.0000 | 0.0000 | 0.0000 | 0.0000 |
| j = 2 | 0.0000 | 0.0000 | 0.0000 | 0.0000 | 0.0000 | 0.0000 | 0.0000 | 0.0000 |
| j = 3 | 0.0000 | 0.0000 | 0.0000 | 0.0000 | 0.0000 | 0.0000 | 0.0000 | 0.0000 |
| j = 4 | 0.0000 | 0.0000 | 0.0000 | 0.0000 | 0.0000 | 0.0000 | 0.0000 | 0.0000 |
| j = 5 | 0.0000 | 0.0000 | 0.0000 | 0.0000 | 0.0000 | 0.0000 | 0.0000 | 0.0000 |
| j = 6 | 0.0000 | 0.0000 | 0.0000 | 0.0000 | 0.0000 | 0.0000 | 0.0000 | 0.0000 |
| j = 7 | 0.0000 | 0.0000 | 0.0000 | 0.0000 | 0.0000 | 0.0000 | 0.0000 | 0.0000 |
| j = 8 | 0.0000 | 0.0000 | 0.0000 | 0.0000 | 0.0000 | 0.0000 | 0.0000 | 0.0000 |
| j = 9 | 0.0000 | 0.0000 | 0.0000 | 0.0000 | 0.0000 | 0.0000 | 0.0000 | 0.0000 |
| j = 10 | 0.0000 | 0.0000 | 0.0000 | 0.0000 | 0.0000 | 0.0000 | 0.0000 | 0.0000 |
| j = 11 | 0.0000 | 0.0000 | 0.0000 | 0.0000 | 0.0000 | 0.0000 | 0.0000 | 0.0000 |
| j = 12 | 0.0000 | 0.0000 | 0.0000 | 0.0000 | 0.0000 | 0.0000 | 0.0000 | 0.0000 |
| j = 13 | 0.0000 | 0.0000 | 0.0000 | 0.0000 | 0.0000 | 0.0000 | 0.0000 | 0.0000 |
| j = 14 | 0.0000 | 0.0000 | 0.0000 | 0.0000 | 0.0000 | 0.0000 | 0.0000 | 0.0000 |
| j = 15 | 0.0000 | 0.0000 | 0.0000 | 0.0000 | 0.0000 | 0.0000 | 0.0000 | 0.0000 |
| j = 16 | 0.0000 | 0.0000 | 0.0000 | 0.0000 | 0.0000 | 0.0000 | 0.0000 | 0.0000 |
| j = 17 | 0.0000 | 0.0000 | 0.0000 | 0.0000 | 0.0000 | 0.0000 | 0.0000 | 0.0000 |
| j = 18 | 0.0000 | 0.0000 | 0.0000 | 0.0000 | 0.0000 | 0.0000 | 0.0000 | 0.0000 |
| j = 19 | 0.0000 | 0.0000 | 0.0000 | 0.0000 | 0.0000 | 0.0000 | 0.0000 | 0.0000 |
| j = 20 | 0.0000 | 0.0000 | 0.0000 | 0.0000 | 0.0000 | 0.0000 | 0.0000 | 0.0000 |
| j = 21 | 0.0000 | 0.0000 | 0.0000 | 0.0000 | 0.0000 | 0.0000 | 0.0000 | 0.0000 |
| j = 22 | 0.0000 | 0.0000 | 0.0000 | 0.0000 | 0.0000 | 0.0000 | 0.0000 | 0.0000 |
| j = 23 | 0.0000 | 0.0000 | 0.0000 | 0.0000 | 0.0000 | 0.0000 | 0.0000 | 0.0000 |
| j = 24 | 0.0000 | 0.0000 | 0.0000 | 0.0000 | 0.0000 | 0.0000 | 0.0000 | 0.0000 |
| j = 25 | 0.0000 | 0.0000 | 0.0000 | 0.0000 | 0.0000 | 0.0000 | 0.0000 | 0.0000 |
| j = 26 | 0.0000 | 0.0000 | 0.0000 | 0.0000 | 0.0000 | 0.0000 | 0.0000 | 0.0000 |
| j = 27 | 0.0000 | 0.0000 | 0.0000 | 0.0000 | 0.0000 | 0.0000 | 0.0000 | 0.0000 |
| j = 28 | 0.0000 | 0.0000 | 0.0000 | 0.0000 | 0.0000 | 0.0000 | 0.0000 | 0.0000 |
| j = 29 | 0.0000 | 0.0000 | 0.0000 | 0.0000 | 0.0000 | 0.0000 | 0.0000 | 0.0000 |
| j = 30 | 0.0000 | 0.0000 | 0.0000 | 0.0000 | 0.0000 | 0.0000 | 0.0000 | 0.0000 |
| j = 31 | 0.0000 | 0.0000 | 0.0000 | 0.0000 | 0.0000 | 0.0000 | 0.0000 | 0.0000 |
| j = 32 | 0.0000 | 0.0000 | 0.0000 | 0.0000 | 0.0000 | 0.0000 | 0.0000 | 0.0000 |
| j = 33 | 0.0000 | 0.0000 | 0.0000 | 0.0000 | 0.0000 | 0.0000 | 0.0000 | 0.0000 |
| j = 34 | 0.0000 | 0.0000 | 0.0000 | 0.0000 | 0.0000 | 0.0000 | 0.0000 | 0.0000 |
| j = 35 | 0.0000 | 0.0000 | 0.0000 | 0.0000 | 0.0000 | 0.0000 | 0.0000 | 0.0000 |
| j = 36 | 0.0000 | 0.0000 | 0.0000 | 0.0000 | 0.0000 | 0.0000 | 0.0000 | 0.0000 |
| j = 37 | 0.0000 | 0.0000 | 0.0000 | 0.0000 | 0.0000 | 0.0000 | 0.0000 | 0.0000 |
| j = 38 | 0.0000 | 0.0000 | 0.0000 | 0.0000 | 0.0000 | 0.0000 | 0.0000 | 0.0000 |
| j = 39 | 0.0000 | 0.0000 | 0.0000 | 0.0000 | 0.0000 | 0.0000 | 0.0000 | 0.0000 |
| j = 40 | 0.0000 | 0.0000 | 0.0000 | 0.0000 | 0.0000 | 0.0000 | 0.0000 | 0.0000 |
| j = 41 | 0.0000 | 0.0000 | 0.0000 | 0.0000 | 0.0000 | 0.0000 | 0.0000 | 0.0000 |
| j = 42 | 0.0000 | 0.0000 | 0.0000 | 0.0000 | 0.0000 | 0.0000 | 0.0000 | 0.0000 |
| j = 43 | 0.0000 | 0.0000 | 0.0000 | 0.0000 | 0.0000 | 0.0000 | 0.0000 | 0.0000 |
| j = 44 | 0.0000 | 0.0000 | 0.0000 | 0.0000 | 0.0000 | 0.0000 | 0.0000 | 0.0000 |
| j = 45 | 0.0003 | 0.0000 | 0.0000 | 0.0000 | 0.0000 | 0.0000 | 0.0000 | 0.0000 |
| j = 46 | −0.0019 | 0.0002 | 0.0000 | 0.0000 | 0.0000 | 0.0000 | 0.0000 | 0.0000 |
| j = 47 | 0.0136 | −0.0016 | 0.0002 | 0.0000 | 0.0000 | 0.0000 | 0.0000 | 0.0000 |
| j = 48 | −0.1212 | 0.0142 | −0.0017 | 0.0002 | 0.0000 | 0.0000 | 0.0000 | 0.0000 |
| j = 49 | 1.0334 | −0.1215 | 0.0144 | −0.0016 | 0.0002 | 0.0000 | 0.0000 | 0.0000 |
| j = 50 | −0.1633 | 1.0353 | −0.1227 | 0.0140 | −0.0021 | 0.0001 | 0.0000 | 0.0000 |
| j = 51 | 0.0222 | −0.1407 | 1.0327 | −0.1177 | 0.0177 | −0.0012 | 0.0002 | 0.0000 |
| j = 52 | −0.0031 | 0.0199 | −0.1462 | 1.0379 | −0.1565 | 0.0108 | −0.0016 | 0.0001 |
| j = 53 | 0.0004 | −0.0028 | 0.0204 | −0.1448 | 1.0307 | −0.0714 | 0.0102 | −0.0009 |
| j = 54 | −0.0001 | 0.0004 | −0.0027 | 0.0188 | −0.1342 | 1.0314 | −0.1479 | 0.0131 |
| j = 55 | 0.0000 | −0.0001 | 0.0004 | −0.0029 | 0.0204 | −0.1571 | 1.0339 | −0.0917 |
| j = 56 | 0.0000 | 0.0000 | −0.0001 | 0.0004 | −0.0027 | 0.0204 | −0.1342 | 1.0315 |
| j = 57 | 0.0000 | 0.0000 | 0.0000 | −0.0001 | 0.0004 | −0.0032 | 0.0208 | −0.1598 |

Elements in column 57 of (B̅)⁻¹ are shown in Table 10.

TABLE 10
Elements in column 57 of (β̅)⁻¹

| Column/ | |
|---|---|
| Number | i = 57 |
| j = 1 | 0.0000 |
| j = 2 | 0.0000 |
| j = 3 | 0.0000 |
| j = 4 | 0.0000 |
| j = 5 | 0.0000 |
| j = 6 | 0.0000 |
| j = 7 | 0.0000 |
| j = 8 | 0.0000 |
| j = 9 | 0.0000 |
| j = 10 | 0.0000 |
| j = 11 | 0.0000 |
| j = 12 | 0.0000 |
| j = 13 | 0.0000 |
| j = 14 | 0.0000 |
| j = 15 | 0.0000 |
| j = 16 | 0.0000 |
| j = 17 | 0.0000 |
| j = 18 | 0.0000 |
| j = 19 | 0.0000 |
| j = 20 | 0.0000 |
| j = 21 | 0.0000 |
| j = 22 | 0.0000 |
| j = 23 | 0.0000 |
| j = 24 | 0.0000 |
| j = 25 | 0.0000 |
| j = 26 | 0.0000 |
| j = 27 | 0.0000 |
| j = 28 | 0.0000 |
| j = 29 | 0.0000 |
| j = 30 | 0.0000 |
| j = 31 | 0.0000 |
| j = 32 | 0.0000 |
| j = 33 | 0.0000 |
| j = 34 | 0.0000 |
| j = 35 | 0.0000 |
| j = 36 | 0.0000 |
| j = 37 | 0.0000 |
| j = 38 | 0.0000 |
| j = 39 | 0.0000 |
| j = 40 | 0.0000 |
| j = 41 | 0.0000 |
| j = 42 | 0.0000 |
| j = 43 | 0.0000 |
| j = 44 | 0.0000 |
| j = 45 | 0.0000 |
| j = 46 | 0.0000 |
| j = 47 | 0.0000 |
| j = 48 | 0.0000 |
| j = 49 | 0.0000 |
| j = 50 | 0.0000 |
| j = 51 | 0.0000 |
| j = 52 | 0.0000 |
| j = 53 | 0.0001 |
| j = 54 | −0.0016 |
| j = 55 | 0.0114 |
| j = 56 | 0.1280 |
| j = 57 | 1.0198 |

d, use the inverse matrix of the influence matrix to decouple the channels according to a measured signal of the flatness meter, specifically as follows:

d1, set a detection force signal Hᵢ of the flatness meter, i ranging from 1 to n, and form a column vector H̅ with Hᵢ, where the force vector H̅ is shown in the second column in Table 11 below.

d2, multiply the inverse matrix (B̅)⁻¹ of the influence matrix by the column vector H̅ to obtain a new vector F̅, which is a channel-decoupled true force vector, where the vector has a total of n elements, and each element is Fᵢ. The vector F̅ is shown in the third column in Table 11 below.

TABLE 11
Detection force signals of flatness
meter before and after decoupling

| Row | Detection | True |
|---|---|---|
| Number | Force/N | Force/N |
| j = 1 | 0 | 0 |
| j = 2 | 0 | 0 |
| j = 3 | 0 | 0 |
| j = 4 | 0 | 0 |
| j = 5 | 0 | 0 |
| j = 6 | 238.732 | 0 |
| j = 7 | 1995.643 | 1818.31 |
| j = 8 | 2282.108 | 1762.41 |
| j = 9 | 2207.028 | 1735.11 |
| j = 10 | 2096.531 | 1684.41 |
| j = 11 | 2024.36 | 1558.31 |
| j = 12 | 1923.888 | 1512.81 |
| j = 13 | 1911.101 | 1495.91 |
| j = 14 | 1821.529 | 1455.61 |
| j = 15 | 1915.391 | 1495.907 |
| j = 16 | 1733.662 | 1356.813 |
| j = 17 | 1722.458 | 1324.31 |
| j = 18 | 1720.238 | 1372.41 |
| j = 19 | 1742.567 | 1345.11 |
| j = 20 | 1638.449 | 1320.41 |
| j = 21 | 1624.467 | 1272.31 |
| j = 22 | 1618.139 | 1278.81 |
| j = 23 | 1575.369 | 1235.91 |
| j = 24 | 1513.801 | 1169.61 |
| j = 25 | 1504.092 | 1183.91 |
| j = 26 | 1527.82 | 1200.81 |
| j = 27 | 1464.216 | 1220.31 |
| j = 28 | 1540.136 | 1216.41 |
| j = 29 | 1535.045 | 1215.11 |
| j = 30 | 1507.28 | 1190.413 |
| j = 31 | 1455.896 | 1168.31 |
| j = 32 | 1522.097 | 1174.81 |
| j = 33 | 1571.552 | 1235.91 |
| j = 34 | 1534.991 | 1195.61 |
| j = 35 | 1552.463 | 1287.91 |
| j = 36 | 1672.224 | 1304.81 |
| j = 37 | 1606.142 | 1272.313 |
| j = 38 | 1723.979 | 1346.41 |
| j = 39 | 1639.386 | 1293.11 |
| j = 40 | 1693.386 | 1372.41 |
| j = 41 | 1692.86 | 1324.31 |
| j = 42 | 1857.333 | 1460.81 |
| j = 43 | 1826.014 | 1443.91 |
| j = 44 | 1798.144 | 1429.61 |
| j = 45 | 1917.445 | 1521.91 |
| j = 46 | 1991.647 | 1564.91 |
| j = 47 | 2025.709 | 1636.31 |
| j = 48 | 2100.595 | 1710.41 |
| j = 49 | 2149.144 | 1735.31 |
| j = 50 | 2299.25 | 1814.41 |
| j = 51 | 2086.986 | 1844.31 |
| j = 52 | 255.6476 | 0 |
| j = 53 | 0 | 0 |
| j = 54 | 0 | 0 |
| j = 55 | 0 | 0 |
| j = 56 | 0 | 0 |
| j = 57 | 0 | 0 |

e, calculate flatness distribution after channel decoupling, specifically as follows:

e1, set a total strip tension T=64 kN, a strip breadth B=1150 mm and a mean strip thickness h=1.0 mm, and calculate a mean strip tensile stress σₘₑₐₙ=T/(Bh)₌55.65 MPa.

e2, divide the strip breadth B by the channel breadth b to get 44.23, and round to obtain a temporary integer m¹=45.

e3, determine that m₁ is an odd integer, and make a strip-covered channel number of the flatness meter m=m₁=45.

e4, make a left boundary number of the strip-covered channel number of the flatness meter m_{z}=(n−m) /2+1=(57−45) /2+1=7, and a right boundary number of the strip-covered channel number of the flatness meter m_{y}=n−(n−m)/2=57−(57−45)/2=51.

e5, calculate a mean force

$$\overline{F} = {\sum }_{i = {m}_{z}}^{{m}_{y}} {F}_{i} \text{/} m = 1412.421 N .$$

e6, set a strip's elastic modulus=210000 MPa E and Poisson's ratio ν=0.3, and calculate

true flatness distribution

$${ɛ}_{i} = \frac{\overline{F} - {F}_{i}}{\overline{F}} {σ}_{m e a n} \frac{1 - {υ}^{2}}{E} \times 1 {0}^{5} ,$$

where i ranges from m_{z} to m_{y}. The calculation results are shown in the third column in Table 12 below. If the detection force vector H̅ is not decoupled, H̅ will be directly used to calculate the flatness distribution. The calculation results are shown in the second column of Table 12.

TABLE 12
Flatness distribution before and after decoupling

| | Flatness before | Flatness after |
|---|---|---|
| Channel | Decoupling/I-Unit | Decoupling I-Unit |
| i = 7 | −2.83506 | −6.88606 |
| i = 8 | −6.70361 | −5.933 |
| i = 9 | −5.6897 | −5.46755 |
| i = 10 | −4.19749 | −4.60314 |
| i = 11 | −3.22286 | −2.45322 |
| i = 12 | −1.86605 | −1.67747 |
| i = 13 | −1.69337 | −1.38934 |
| i = 14 | −0.48374 | −0.70225 |
| i = 15 | −1.7513 | −1.38929 |
| i = 16 | 0.702855 | 0.982187 |
| i = 17 | 0.854151 | 1.536337 |
| i = 18 | 0.884136 | 0.716261 |
| i = 19 | 0.582598 | 1.18171 |
| i = 20 | 1.987974 | 1.602829 |
| i = 21 | 2.177471 | 2.422904 |
| i = 22 | 2.262932 | 2.312083 |
| i = 23 | 2.840517 | 3.043502 |
| i = 24 | 3.671959 | 4.173876 |
| i = 25 | 3.803066 | 3.930069 |
| i = 26 | 3.482638 | 3.641935 |
| i = 27 | 4.341572 | 3.309472 |
| i = 28 | 3.316314 | 3.375965 |
| i = 29 | 3.385063 | 3.398129 |
| i = 30 | 3.760019 | 3.819204 |
| i = 31 | 4.453929 | 4.19604 |
| i = 32 | 3.559918 | 4.085219 |
| i = 33 | 2.892061 | 3.043502 |
| i = 34 | 3.3858 | 3.730592 |
| i = 35 | 3.14985 | 2.156934 |
| i = 36 | 1.532541 | 1.8688 |
| i = 37 | 2.424937 | 2.42286 |
| i = 38 | 0.833611 | 1.159545 |
| i = 39 | 1.976 | 2.068277 |
| i = 40 | 1.248629 | 0.716261 |
| i = 41 | 1.253861 | 1.536337 |
| i = 42 | −0.96726 | −0.7909 |
| i = 43 | −0.54431 | −0.50277 |
| i = 44 | −0.16795 | −0.25896 |
| i = 45 | −1.77904 | −1.83262 |
| i = 46 | −2.78109 | −2.56404 |
| i = 47 | −3.24109 | −3.78307 |
| i = 48 | −4.25237 | −5.04643 |
| i = 49 | −4.90801 | −5.46755 |
| i = 50 | −6.9351 | −6.81956 |
| i = 51 | −4.0686 | −7.32934 |

According to the second and third columns of Table 12 and FIG. 4, if the detection force vector H̅ is not decoupled, as shown by curve L1 of FIG. 4, there will be a flatness error of 2-4 (I-Unit) occurring on channels at both edges of the strip, which indicates that the calculated overall flatness error is large. After the detection force vector H̅ is decoupled through the inverse matrix of the influence matrix, as shown by curve L2 in FIG. 4, flatness detected by the channels at both edges tend to be reasonable, that is, the true force vector and flatness distribution are reproduced.

The present invention decouples the channel of the whole-roller flatness meter by inverting the influence matrix and multiplying with the detection force vector, thereby reproducing the true force vector and flatness distribution and improving the flatness detection accuracy.

Finally, it should be noted that the above examples are merely intended to illustrate the present invention, rather than to limit the technical solutions described in the present invention. Therefore, those of ordinary skill in the art should understand that although this specification describes the present invention in detail with reference to the above-mentioned examples, the present invention can still be modified or equivalently replaced. All technical solutions and improvements made without deviating from the spirit and scope of the present invention should be covered by the scope of the claims of the present invention.

What is claimed is:

1. A method for channel decoupling of a whole-roller flatness meter for a cold-rolled strip, comprising the following steps executed by artificial calibration and by a computer:
a, setting a channel number n and a channel breadth b of the flatness meter;
b, obtaining an influence matrix under the condition of signal interference between the channels, which comprises the following steps:
b1, making a temporary variable i=1;
b2, making a temporary variable j=1;
b3, using a calibration device to apply a calibration force to an i channel of the flatness meter;
b4, recording an analog/digital (AD) influence value αⱼᵢ of the i channel on a j channel;
b5, determining whether j=n is true; if yes, going to b6; if not, making j=j+1 and returning to b4;
b6, determining whether i=n is true; if yes, going to b7; if not, making i=i+1 and returning to b3;
b7, making a temporary variable i=1;
b8, making a temporary variable j=1;
b9, calculating an influence coefficient βⱼᵢ=αⱼᵢ /αⱼⱼ of the i channel on the j channel;
b10, determining whether j=n is true; if yes, going to b11; if not, making j=j+1 and returning to b9;
b11, determining whether i=n is true; if yes, going to b12; if not, making i=i+1 and returning to b9; and
b12, forming an influence matrix B̅ of coupled channels with all, Bⱼⱼ , B̅ being a square matrix, wherein j is a row number of the matrix, ranging from 1 to n, and i is a column number of the matrix, ranging from 1 to n;
c, calculating an inverse matrix (B̅)⁻¹ of the influence matrix;
d, using the inverse matrix of the influence matrix to decouple the channels according to a measured signal of the flatness meter; and
e, obtaining flatness distribution after channel decoupling.

2. The method for channel decoupling of a whole-roller flatness meter for a cold-rolled strip according to claim 1, wherein step d specifically comprises:
d1, setting a detection force signal Hᵢ of the flatness meter, i ranging from 1 to n, and forming a column vector H̅ with Hᵢ; and
d2, multiplying the inverse matrix (B̅)⁻¹ of the influence matrix by the column vector H̅ to obtain a channel-decoupled true force vector F̅, wherein the true force vector F̅ has a total of n elements, and each element is Fᵢ.

3. The method for channel decoupling of a whole-roller flatness meter for a cold-rolled strip according to claim 1, wherein step e specifically comprises:
e1, setting a total strip tension T, a strip breadth B and a mean strip thickness h, and calculating a mean strip tensile stress σₘₑₐₙ=T/(Bh).
e2, dividing the strip breadth B by the channel breadth b and rounding to obtain a temporary integer mⁱ;
e3, determining whether m₁ is an odd number; if yes, making a strip-covered channel number of the flatness meter m=m₁, and going to e4; if not, making the strip-covered channel number of the flatness meter m=m₁+1, and going to e4;
e4, making a left boundary number of the strip-covered channel number of the flatness meter m_{z}=(n−m)/2+1, and a right boundary number of the strip-covered channel number of the flatness meter m_{y}=n−(n−m)/2;
e5, calculating a mean force
$$\overline{F} = {\sum }_{i = {m}_{z}}^{{m}_{y}} {F}_{i} \text{/} m ;$$
and
e6, setting an elastic modulus E and a Poisson's ratio ν of a strip, and calculating true flatness distribution
$${ɛ}_{i} = \frac{\overline{F} - {F}_{i}}{\overline{F}} {σ}_{m e a n} \frac{1 - {υ}^{2}}{E} \times 1 {0}^{5} ,$$
wherein i ranges from m_{z} to m_{y}.

4. The method for channel decoupling of a whole-roller flatness meter for a cold-rolled strip according to claim 2, wherein step e specifically comprises:
e1, setting a total strip tension T, a strip breadth B and a mean strip thickness h, and calculating a mean strip tensile stress σₘₑₐₙ=T/(Bh);
e2, dividing the strip breadth B by the channel breadth b and rounding to obtain a temporary integer m₁;
e3, determining whether m₁ is an odd number; if yes, making a strip-covered channel number of the flatness meter m=m₁, and going to e4; if not, making the strip-covered channel number of the flatness meter m=mᵢ +1, and going to e4;
e4, making a left boundary number of the strip-covered channel number of the flatness meter m_{z}=(n−m)/2+1, and a right boundary number of the strip-covered channel number of the flatness meter m_{y}=n−(n−m)2;
e5, calculating a mean force
$$\overline{F} = {\sum }_{i = {m}_{z}}^{{m}_{y}} {F}_{i} \text{/} m ;$$
and
e6, setting an elastic modulus E and a Poisson's ratio ν of a strip, and calculating true flatness distribution
$${ɛ}_{i} = \frac{\overline{F} - {F}_{i}}{\overline{F}} {σ}_{m e a n} \frac{1 - {υ}^{2}}{E} \times 1 {0}^{5} ,$$
wherein i ranges from m_{z} to m_{y}.
